(19) United States
(12) Patent Application Publication
(10) Pub. No.: US 2009/0205503 A1
(43) Pub. Date: Aug. 20, 2009

(54) Percolating Machine for Making a Beverage

(76) Inventor: Virginio Cortese, Torino (IT)

Correspondence Address: LADAS & PARRY LLP, 26 WEST 61ST STREET, NEW YORK, NY, 10023, US

(21) Appl. No.: 11/887,466

(22) PCT Filed: Mar. 28, 2006
(86) PCT No.: PCT/EP2006/061097

§ 371 Date: Apr. 8, 2009

(30) Foreign Application Priority Data
Mar. 30, 2005 (IT) TO2005A 000209

(51) Int. Cl. A47J 31/40; A47J 31/24

(52) U.S. Cl. 99/295; 99/302 R

(57) ABSTRACT

A percolating machine for making a beverage from powdered material in a container, the machine having a pressurized-hot-water dispenser having a sprinkler; and a thrust member having a seat for at least partly housing the container; the dispenser and the thrust member are aligned along an axis, are both movable along the axis to and from an infusion position, and are connected by a transmission so that movement of the thrust member along the axis in one direction corresponds to movement of the dispenser along the axis in the opposite direction.

### TECHNICAL FIELD

The present invention relates to a percolating machine for making a beverage from powdered material inside a container.

### BACKGROUND ART

More specifically, the present invention relates to a percolating machine for making a beverage from powdered material inside a container, the machine comprising a frame; a first member comprising a seat for at least partly housing said container; and a second member facing the first member and comprising a pressurized-hot-water sprinkler; the first and second member being fitted movably to the frame, and a transmission being interposed between the first and second member to move the first and second member along a first axis, with respect to each other and to the frame, to and from an infusion position, in which the container, housed, in use, inside said seat, is gripped in fluidtight manner against the sprinkler. Percolating machines of the type described above are known, for example, from U.S. Pat. No. 6,505,544 and U.S. Pat. No. 4,220, 259.

Though the machine according to the present invention is designed to percolate any type of beverage produced by feeding pressurized hot water through a relative powdered or substantially anhydrous granulated food substance inside a container, specific reference is made in the following description, purely by way of example, to a machine for making a coffee beverage using a container containing a respective measure of ground coffee.

### DISCLOSURE OF INVENTION

It is an object of the present invention to provide a beverage percolating machine of the above type, which is cheap and easy to produce, and which provides for moving the first and second member rapidly into the infusion position.

According to the present invention, there is provided a percolating machine for making a beverage, as claimed in claim 1 and, preferably, in any one of the following Claims depending directly or indirectly on claim 1.

### BRIEF DESCRIPTION OF THE DRAWINGS

The invention will now be described by way of examples with reference to the accompanying drawings, in which:

FIG. 1 shows a view in perspective of a first preferred embodiment of the machine according to the present invention;

FIGS. 2 and 3 show partly sectioned views, with parts removed for clarity, of the FIG. 1 machine in different operating configurations;

FIGS. 4 and 5 show partly sectioned views, with parts removed for clarity, of a second and third preferred embodiment respectively of the machine according to the present invention.

### BEST MODE FOR CARRYING OUT THE INVENTION

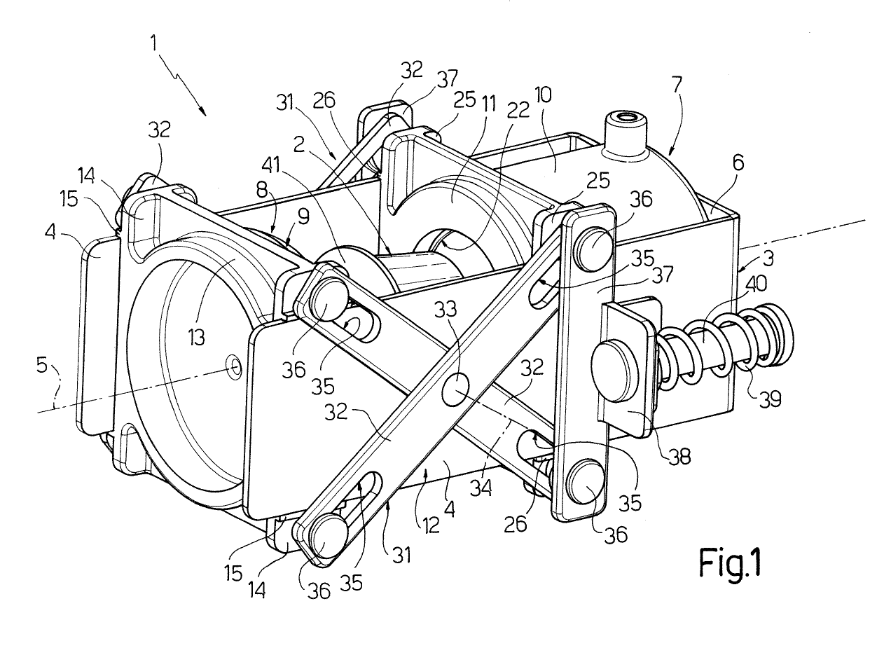

Number 1 in FIG. 1 indicates as a whole a percolating machine for making a coffee beverage from a measure of ground coffee in a container 2.

Machine 1 comprises a frame 3, in turn comprising two substantially rectangular plates 4 positioned symmetrically on opposite sides of and parallel to a horizontal axis 5, and connected to each other, at one longitudinal end, by a transverse wall 6.

Between the two plates 4, are housed, facing each other, a thrust assembly 7 located close to transverse wall 6; and a hot-water dispenser 8, which is aligned with thrust assembly 7 along axis 5, is mounted to move along axis 5, and comprises a known boiler (not shown) supplied with pressurized water by a known pump (not shown), and a sprinkler 9 connected to the boiler and supplied by the boiler with pressurized hot water via a known one-way valve (not shown) calibrated to open when the pressure upstream from the one-way valve reaches a given value.

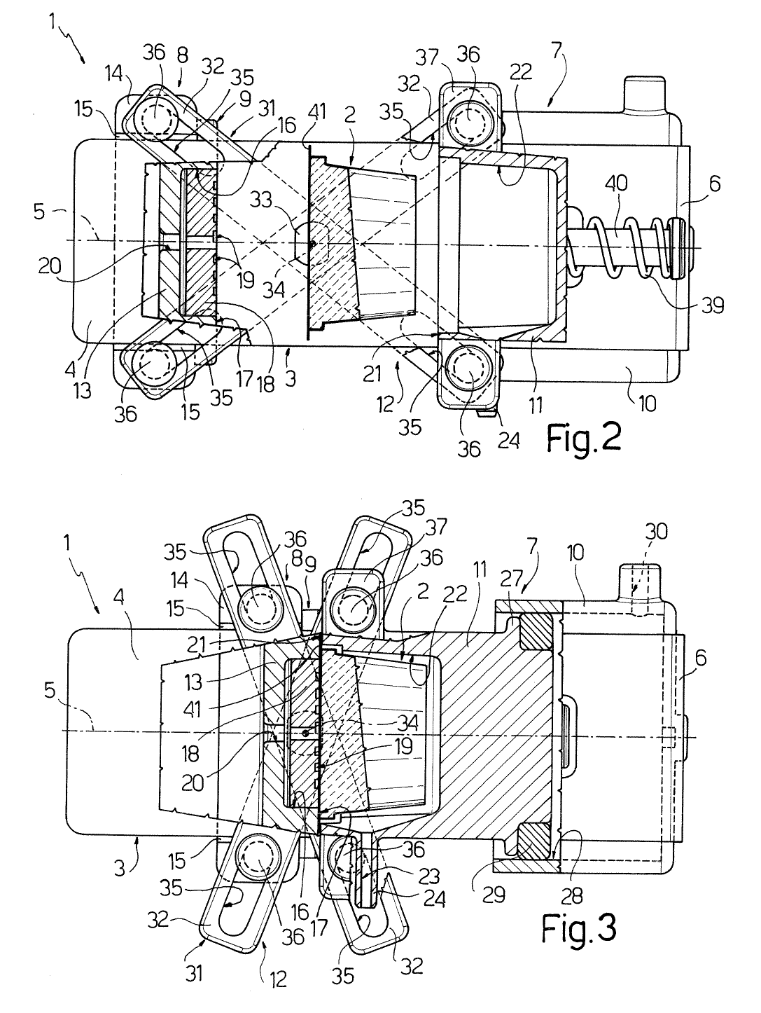

With reference to FIG. 1, thrust assembly 7 is defined by a hydraulic cylinder comprising a tubular body 10 integral with frame 3 and coaxial with axis 5; and a piston 11 facing sprinkler 9 and which slides axially along tubular body 10 between a withdrawn position (FIG. 2) and an extracted position (FIG. 3) which coincides with an infusion position engaging sprinkler 9.

Piston 11 is also connected to dispenser 8 by a transmission 12, which, as explained in detail below, moves dispenser 8 along axis 5 in response to displacement of piston 11 along axis 5.

As shown in more detail in FIGS. 2 and 3, sprinkler 9 comprises a cup-shaped body 13 fitted to frame 3 to slide axially on two skids defined by respective plates 14, each of which is connected to the lateral wall of cup-shaped body 13, is positioned diametrically opposite the other plate 14 and facing a respective plate 4 of frame 3, and has two ribs 15 parallel to each other and to axis 5, and projecting outwards from respective plate 14, at opposite edges of relative plate 4, to define a runner which slides along plate 4.

On the side facing thrust assembly 7, cup-shaped body 13 comprises a central cavity 16 coaxial with axis 5 and bounded along its free edge by a flat annular surface 17 crosswise to axis 5.

A plate 18 is fitted inside cavity 16, coaxially with axis 5, and comprises, on the surface facing piston 11, a number of grooves 19 along which is distributed, in use, pressurized water fed to grooves 19 along a feed conduit 20 formed axially through plate 18 and cup-shaped body 13.

Piston 11 has an end portion which, even when piston 11 is in the withdrawn position, projects from tubular body 10, and which is bounded, on the side facing sprinkler 9, by a flat surface 21 crosswise to axis 5. A truncated-cone-shaped seat 22, for housing a container 2, is formed in surface 21, coaxially with axis 5, and communicates with the outside along a drain conduit 23 formed through a percolating spout 24.

With reference to FIG. 1, on either side of the end portion of piston 11, and facing respective plates 4, piston 11 is fitted with two skids identical to those on cup-shaped body 13, and which guide piston 11 along axis 5, and lock piston 11 angularly about axis 5 with respect to tubular body 10. Each skid comprises a plate 25, and two ribs 26 projecting outwards from respective plate 25, at opposite edges of relative plate 4, to define a runner which slides along plate 4.

As shown in FIG. 3, piston 11 has an end flange 27 which faces an inner end wall of tubular body 10, extends radially from piston 11 up to tubular body 10, and defines, between piston 11 and said end wall, a variable-volume chamber 28, which is sealed in fluidtight manner by an annular seal 29 fitted to the end of piston 11, and is supplied with water, by which to operate piston 11, along a feed conduit 30 formed through tubular body 10.

As shown in FIGS. 1, 2 and 3, transmission 12 is a crossbar transmission, and comprises two cross members 31 located outside frame 3, on opposite sides of axis 5, and connecting dispenser 8 to thrust assembly 7, so that each movement of piston 11 along axis 5 corresponds to a like and opposite movement of dispenser 8 along axis 5.

More specifically, each cross member: 31 comprises two rocker arms 32 hinged at respective intermediate points to a relative plate 4 by a pin 33 to oscillate about a horizontal axis 34 perpendicular to axis 5.

As shown in FIGS. 2 and 3, each rocker arm 32 slopes with respect to axis 5 at the same angle as, but in the opposite direction to, the other rocker arm 32 of the same cross member 31, and extends, parallel to relative plate 4, from plate 14 to plate 25, both connected to plate 4. Each rocker arm 32 has two end slots 35, each of which is engaged in transversely-sliding manner by a respective pin 36 parallel to axis 34 and connected to a free end of respective plate 14, 25.

The two pins 36 of each plate 25 are connected to each other by a respective bar 37 crosswise to axis 5 and parallel to relative plate 4. A respective L-shaped bracket 38 is welded to each bar 27 and, together with the other bracket 38, forms part of a piston return device comprising, in addition to brackets 38, two springs 39 for restoring piston 11 from the extracted to the withdrawn position, once pressurized-water supply to chamber 28 ceases, and which are wound about respective pins 40 parallel to axis 5 and connected at one end to relative brackets 38 and at the opposite end to frame 3.

In connection with the above, it should be pointed out that, in an alternative embodiment (not shown), transmission 12 may comprise only one cross member 31, i.e. one pair of rocker arms 32 hinged to one of the two plates 4.

It should also be pointed out that, on machine 1 as described above and illustrated in FIGS. 2 and 3, the type of container 2 used (and shown in FIGS. 2 and 3) is a known perforated rigid capsule, i.e. defined by two perforated end walls connected by a truncated-cone-shaped lateral wall with an outer annular flange 41 at one end.

Machine 1, however, can also be used with a container 2 in the form of a known sealed capsule, i.e. defined by a cup-shaped body comprising an end wall, and a truncated-cone-shaped lateral wall having annular flange 41 and sealed in fluidtight manner by a sealing wall 42—normally of foil—peripherally integral with the outer surface of annular flange 41.

When sealed capsules of this sort are used, percolating machine 1 is equipped with piercing devices for piercing the sealed capsule to allow pressurized water into, and the beverage to flow out of, the capsule.

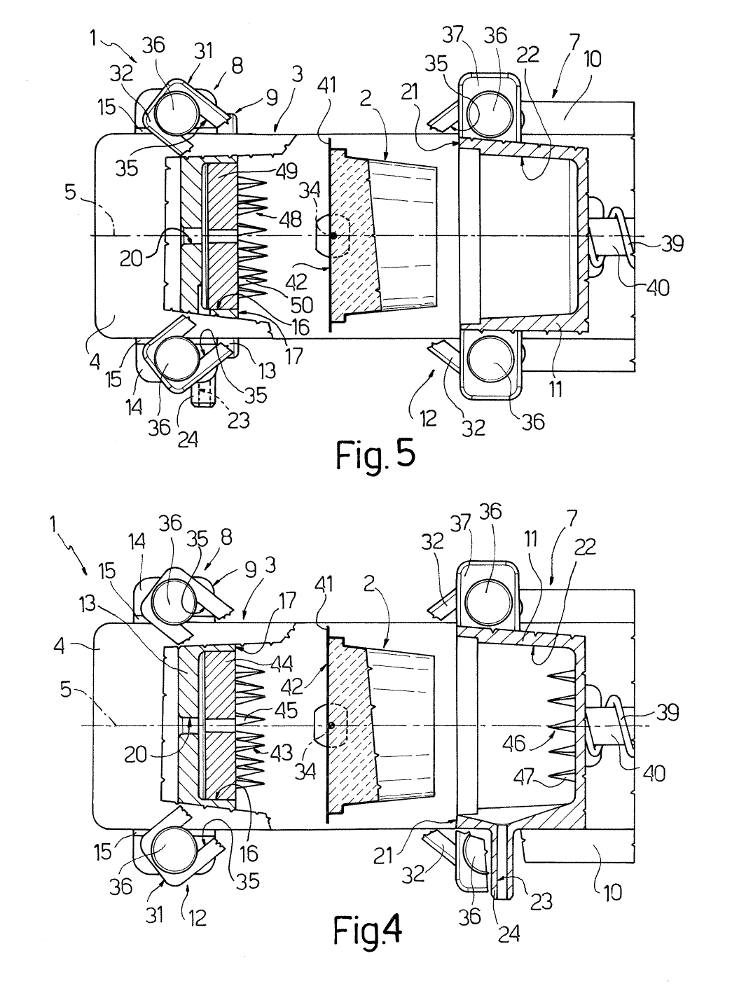

In the FIG. 4 embodiment, machine 1 comprises a piercing device 43 fitted to dispenser 8 and comprising a circular plate 44 similar to plate 18 in the FIG. 2 and 3 embodiment, but comprising a number of hollow (known) water injection needles 45 integral with one another and with plate 44, and extending, parallel to axis 5, from plate 44 towards piston 11.

With reference to FIG. 4, machine 1 also comprises a further piercing device 46 fitted to piston 11 and comprising a number of beverage extraction needles 47 (known) connected to the bottom of seat 22 and projecting, parallel to axis 5, from the bottom of seat 22 towards sprinkler 9.

In the FIG. 5 embodiment, machine 1 comprises one piercing device 48, in turn comprising a plate 49 housed inside cavity 16 of sprinkler 9, and a number of hollow needles 50 integral with plate 49 and substantially parallel to axis 5.

Since, in the latter case, water is injected into container 2, and the beverage extracted (in known manner), on the same side of container 2, percolating spout 24 is connected to cup-shaped body 13 of sprinkler 9, as opposed to tubular body 10 of the hydraulic cylinder (as in the FIG. 2, 3 and 4 embodiments).

Operation of machine 1 will now be described with reference to the FIG. 2 and 3 embodiment employing a perforated capsule, and therefore having no capsule piercing devices.

FIG. 2 shows machine 1 in a loading position, in which the user inserts between sprinkler 9 and piston 11—which is in the withdrawn position detached from sprinkler 9—a container 2 positioned with its flange 41 facing sprinkler 9. Container 2 is retained in this position by known retaining devices not shown.

When machine 1 is operated by the user, pressurized water is pumped into chamber 28 along feed conduit 30, thus moving piston 11 from the withdrawn to the extracted position.

As piston 11 moves along axis 5, pins 36 integral with plates 25 of piston 11 begin sliding along respective slots 35, and so push rocker arms 32 of each cross member 31 in opposite directions about axis 34; which rotation is made possible by pins 36 integral with plates 14 simultaneously sliding along respective slots 35.

As rocker arms 32 contract “scissor-fashion”, dispenser 8 is moved towards thrust assembly 7 to bring the two gradually together; and, as piston 11 moves towards sprinkler 9, container 2 is gradually inserted inside seat 22.

By the time piston 11 reaches the extracted, i.e. infusion, position (FIG. 3), container 2 is inserted completely inside seat 22, and flange 41 is gripped in fluidtight manner between surface 17 of sprinkler 9 and surface 21 of piston 11.

The sharp rise in pressure, at this point, inside chamber 28 and in the hydraulic circuit portion upstream from the one-way valve (not shown) opens the one-way valve, so that pressurized hot water flows into container 2 along feed conduit 20, the ground coffee is percolated, and the coffee beverage flows out of percolating spout 24 along drain conduit 23.

Upon the user pressing a stop button (not shown), the water supply is cut off, and piston 11 is backed up into the withdrawn position by the return action of springs 39.

As when moving forward, the withdrawal movement of piston 11 rotates rocker arms 32 in opposite directions about axis 34, and in reverse directions to before, to “expand” each cross member 31 and so move dispenser 8 and piston 11 away from each other.

In the case of the FIG. 4 machine 1, as piston 11 and sprinkler 9 finally come together, needles 45 integral with plate 44 penetrate container 2 through sealing wall 42, and needles 47 penetrate container 2 through the bottom wall of the container 2, so that pressurized hot water is pumped directly into the capsule by needles 45, and, after impregnating the ground coffee, flows out, through the slits formed by needles 47, from the bottom wall into seat 22 and out along drain conduit 23.

In a variation not shown, machine 1 may be vertical, i.e. axis 5 may be vertical as opposed to horizontal.

To conclude, by virtue of transmission 12 moving dispenser 8 by the same amount as and in the opposite direction to piston 11, the distance piston 11 would otherwise have to travel between the withdrawn and infusion position, if dispenser 8 were fixed to frame 3, is halved.

Halving the travel of piston 11 obviously also halves the time taken by piston 11 to move from the withdrawn to the infusion position.

For the reasons stated, the above time reduction obviously has the advantage of directly reducing the time lapse between the user loading a container 2 and starting machine 1, and the coffee beverage actually being dispensed.

1. A percolating machine (1) for making a beverage from powdered material inside a container (2), the machine (1) comprising a frame (3); a first member (11) comprising a seat (22) for at least partly housing said container (2); and a second member (8) facing the first member (11) and comprising a pressurized-hot-water sprinkler (9); the first and second member (11, 8) being fitted movably to the frame (3), and a transmission (12) being interposed between the first and second member (11, 8) to move the first and second member (11, 8) along a first axis (5), with respect to each other and to the frame (3), to and from an infusion position, in which the container (2), housed, in use, inside said seat (22), is gripped in fluidtight manner against the sprinkler (9); the machine being characterized in that the transmission (12) is an articulated crossbar transmission comprising at least one articulated cross member (31) interposed between the first and second member (11, 8) and hinged to the frame (3), so that a first movement, with respect to the frame (3), of the first member (11) in one direction corresponds to a second movement, with respect to the frame (3), of the second member (8) in the opposite direction.

2. A machine as claimed in claim 1, wherein the first and second member (11, 8) are aligned along the first axis (5).

3. A machine as claimed in claim 1, wherein said first and said second movement are equal in absolute value.

4. A machine as claimed in claims 1, wherein one of the first and second members (11, 8) is a drive member, and the other a driven member.

5. A machine as claimed in claim 4, wherein the first member (11) is the drive member.

6. A machine as claimed in claim 5, wherein said transmission (12) comprises two identical articulated cross members (31) located on opposite sides of the first axis (5).

7. A machine as claimed in claims 1, wherein the frame (3) has a second axis (34) perpendicular to the first axis (5); the articulated cross member (31) comprising two rocker arms (32) hinged to the frame (3) to oscillate, with respect to the frame (3) and in opposite directions, about the second axis (34); each rocker arm (32) being connected at one end to the first member (11) and at the opposite end to the second member (8).

8. A machine as claimed in claim 7, wherein the first (5) and second axis (34) are horizontal axes.

9. A machine as claimed in claim 7, wherein the first axis (5) is a vertical axis, and the second axis (34) is a horizontal axis.

10. A machine as claimed in claim 2, and comprising first guide means (14, 15) interposed between the frame (3) and the first member (11), and second guide means (25, 26) interposed between the frame (3) and the second member (8), to guide the first (11) and second (8) member respectively along the first axis (5).

11. A machine as claimed in claims 1, and comprising a hydraulic cylinder, in turn comprising a tubular body (10) coaxial with the first axis (5) and integral with the frame (3), and a piston fitted in axially-sliding, angularly-fixed manner to said tubular body (10) to move, along the first axis (5), to and from an extracted position; the first member (11) being defined by said piston, and the extracted position coinciding with said infusion position.

12. A machine as claimed in claim 11, and comprising return means (39) for withdrawing the piston (11) from said extracted position.

13. A machine as claimed in claim 12, wherein said return means (39) are elastic means, and comprise at least one spring (39) parallel to said first axis (5) and interposed between the piston (11) and the frame (3).

14. A machine as claimed in claim 11, wherein said seat (22) is formed at one end of said piston (11), is coaxial with the first axis (5), and faces the sprinkler (9).

15. A machine as claimed in claim 1, and comprising at least one piercing device (43, 46; 48) for piercing said container (2); the piercing device (43, 46; 48) comprising a number of needles (45, 47; 50) extending in a direction substantially parallel to the first axis (5).

16. A machine as claimed in claim 15, and comprising two piercing devices (43, 46) for piercing said container (2), and of which a first piercing device (46) is carried by the first member (11), and a second piercing device (43) is carried by the second member (8).

17. A machine as claimed in claim 15, and comprising only one piercing device (48) carried by the second member (8).
